(19) United States
(12) Patent Application Publication
(10) Pub. No.: US 2009/0024576 A1
(43) Pub. Date: Jan. 22, 2009

(54) METHOD AND APPARATUS FOR GENERATING PRIORITIZED SEARCH RESULTS INCLUDING AN EXPRESSION OF INTEREST FACTOR FOR A LIMITED SUPPLY SYSTEM

(76) Inventors: Chyr-Chong Ting, San Jose, CA (US); Naveen Gupta, Sunnyvale, CA (US); Adam Hyder, Los Altos, CA (US)

Correspondence Address: YAHOO! INC.;C/O DREIER LLP, 499 PARK AVENUE, NEW YORK, NY, 10022, US

(21) Appl. No.: 11/780,105

(22) Filed: Jul. 19, 2007

(51) Int. Cl. G06F 7/00

(52) U.S. Cl. 707/3

(57) ABSTRACT

The present invention provides for generation of prioritized search results in a limited supply system, which includes receiving a search request having search request parameters, which may be received through the Internet by a search portal and the search parameters may be the search terms submitted by the user. The present invention further includes determining one or more search result elements for the limited supply system based on the search request parameters, where each of the search result elements indicate a corresponding listing entity and calculating expression of interest (EOI) terms for each of the search result elements based on search result obligations between the limited supply system and the listing entities. Thereupon, the present invention includes prioritizing the search result terms based on the corresponding EOI terms, which may then be presented to the search requesting entity.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to prioritizing limited supplies in a limited supplies system. More particularly, the methods, systems and computer media for calculating an Expression of Interest (EOI) term is used in conjunction with a plurality of relevancy factors for prioritizing limited supplies associated with a search query in a limited supply system.

### BACKGROUND OF THE INVENTION

There are many well-known basic web-based content searching techniques, using search engines to search network-available content for items of interest. While originally employed for finding content, such as web pages, articles, images, for example, systems have evolved to provide for additional levels of content searching. One such example is inventory-based searching, such as searching a defined database or databases of a particular inventory of specific items.

One sample type of inventory is commonly referred to as a limited supply system. These systems represent a limited inventory of content elements. For example, a sample limited supply system may be a real estate database that has a limited inventory of available homes or apartments available for rent or sale. A limited supply system is contrast to a standard or unlimited supply system, such as a commercial database that has an almost unlimited inventory amount.

Limited supply systems differ with respect to search technology because there is an upper threshold of effectiveness of search results for these systems. By contrast, an unlimited system benefits from every search result. This can be exemplified by the example of an inventory database for an online merchant, every time a search result returns a listing for a particular item for sale, the merchant has the opportunity to make another sale, and a replacement for the purchased item can be re-ordered to restock the merchant's inventory.

Using the example of a real estate limited supply system, there is a significantly diminished value to the 500th visitor to the content listing compared with the first visitor. Whereas the merchant in the unlimited supply system could potentially sell 500 items to 500 customers, the limited supply system vendor can only sell one house or rent one apartment to one of the any number of potential customers.

The existing systems incorporate techniques to prioritize search result elements, existing search engines fail to account for the differences between limited and unlimited supply systems. As such, both users and content providers experience decreased performance in the presentation of search results for search content and there exists a need for the improved performance in the prioritization of search results for content relating to limited supply systems.

### SUMMARY OF THE INVENTION

Generally, the present invention provides for the generation of prioritized search results in a limited supply system. As described above, a limited supply system is an inventory having a limited supply of unique content elements. The present invention includes receiving a search request having search request parameters. The search request may be received through the Internet by a search portal and the search parameters may be the search terms submitted by the user.

The present invention further includes determining one or more search result elements for the limited supply system based on the search request parameters, where each of the search result elements indicate a corresponding listing entity. For example, a limited supply system may be a jobs database and the search result elements may be the specific job listings having the potential employer or recruiting agent as the listing entity.

The present invention further includes calculating expression of interest (EOI) terms for each of the search result elements based on search result obligations between the limited supply system and the listing entities. As described in greater detail below, the EOI term relates to the measure of the interaction between a user and a series of one or more actions relative the search result elements of a current search and to previous or future searches. For example, in a limited supply system for employment opportunities, the EOI term may relate to the rate at which a given user clicks and views a particular job listing or the rate at which a given user applies to or not apply to a specific job listing in the current search or in previous searches. In other words, EOI may be fixed on a specific action or intersection of actions to thereby maximize profit, e.g., where a contract pays according to an apply rate, EOI may be tracked in accordance with an apply action.

Thereupon, the present invention includes prioritizing the search result terms based on the corresponding EOI terms. The prioritized search result terms may then be presented to the search requesting entity, the results being prioritized for not only the search requester, but also for the structure of the inventory of the limited supply system.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a computing system including one embodiment operative to perform a method for generating prioritized search results in a limited supply system associated with a search request;

FIG. 2 illustrates a block diagram of a computer system which includes another embodiment operative to perform a method for generating prioritized search results in a limited supply system associated with a search request;

FIG. 3 illustrates a flow chart of the steps of generating search results according to one embodiment of a method for generating prioritized search results in a limited supply system associated with a search request;

FIG. 4 illustrates a table of sample results of one embodiment of a method for generating prioritized search results in a limited supply system associated with a search request;

FIG. 5 illustrates a flow chart of the steps of one embodiment of a method generating prioritized search results in a limited supply system associated with a search request;

FIG. 6 illustrates a table of sample results of another embodiment of a method for generating prioritized search results in a limited supply system associated with a search request;

FIG. 7 illustrates a flow chart of the steps of another embodiment of a method for generating prioritized search results in a limited supply system associated with a search request.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

FIG. 1 illustrates a system 100 that includes a user 102, a user computer 104, a computer network 106, a search provider 108, a search content database 110, and a processing device 112. The processing device utilizes processing elements such as an Expression of Interest (EOI) processing element 114, a click through rate (CTR) and apply rate (AR) processing element 116, a relevance processing element 118, and an other factor processing element 120.

The user computer 104 may be any type of suitable computing device. The computer network 106 may be any type of computerized network capable of transferring data such as the Internet. The search content database 110 may be one or more data storage devices of any suitable type, operative to store corresponding data therein. The processing device 112 may be one or more processing elements operative to perform processing operations in response to executable instructions, collectively as a single element or as various processing modules.

In one embodiment, the user 102 operates the user computer 104, which is in communication across the network 106 with the search provider 108. The user 102 inputs a search request having search request parameters into the user computer 104 for searching in a limited supply system, such as, for example, a database of listings associated with employment opportunities or a real estate market. The user computer 104 communicates the search request to the search provider 108 over the computer network 106. The search provider 108 receives the search request and locates search results associated with the search request in the search content database 110. The processing device 112 then sorts and prioritizes the located limited supplies content according to a plurality of factors. The plurality of factors are associated with separate processing elements such as the EOI processing element 114, the CTR/AR processing element 116, the relevance processing element 118, and the other factor processing element 120. As described in further detail below, the processing device 112 may sort and prioritize the located limited supply content according to one or more of these factors. The search provider 108 then displays the prioritized search results for the limited supplies content to the user 102 over the computer network 106 on the user computer 104.

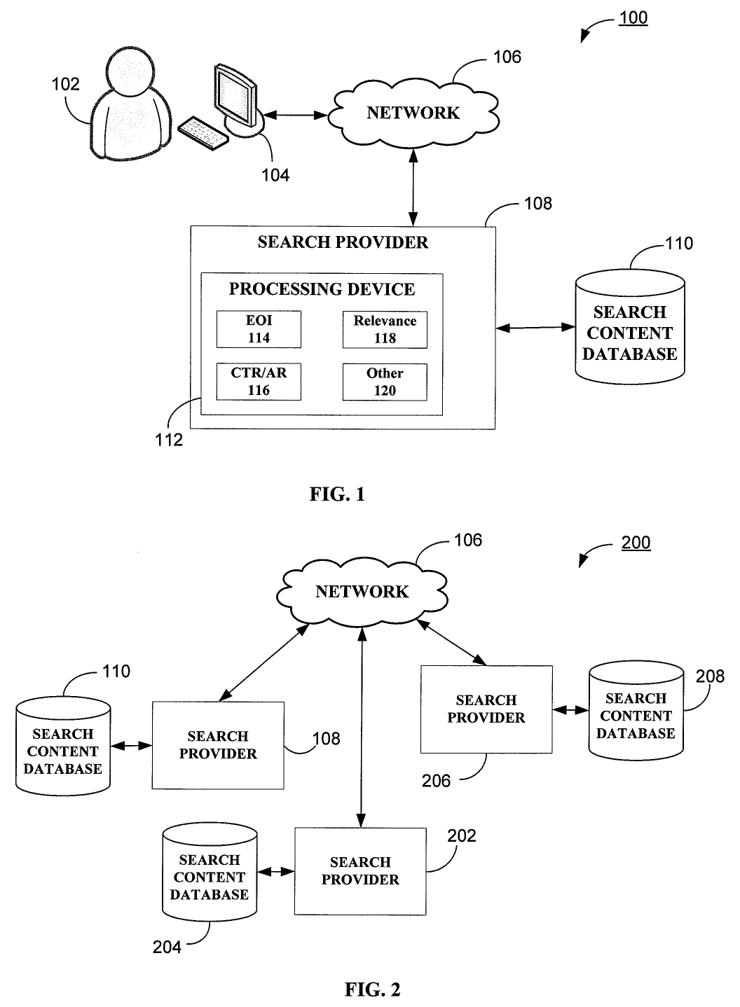

FIG. 2 illustrates another embodiment where a system 200 includes the computer network 106, the search provider 108, the search content database 110 and multiple other search providers, 202 and 206, and multiple other search content databases, 204 and 208. The system 200 illustrated in FIG. 2 operates in the same manner as the system 100 illustrated in FIG. 1, wherein the search provider 108 locates search results associated with the search request in the search content database 110 and the processing device 112 of FIG. 1 prioritizes the located limited supplies content according to a plurality of factors.

The system 200 provides another embodiment by providing the ability for the search provider 108 to communicate with the other search providers, 202 and 206, and the associated other search content databases, 204 and 208, over the computer network 106 in order for the search provider 108 to locate additional search results associated with the original search request.

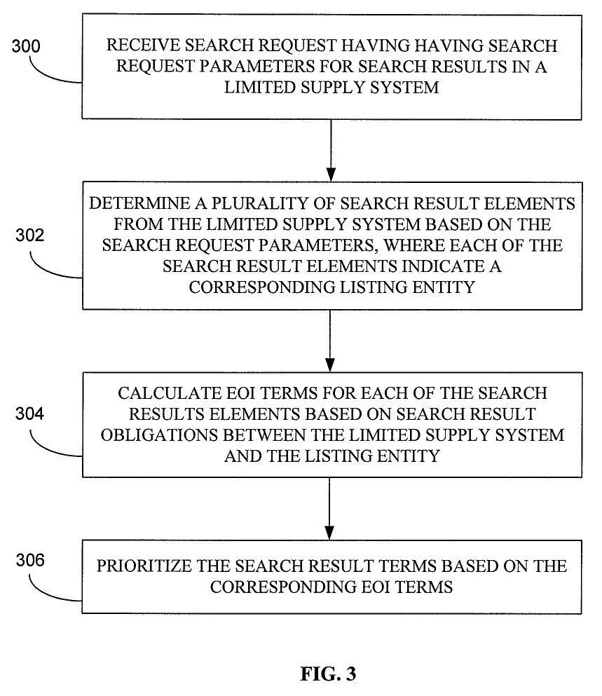

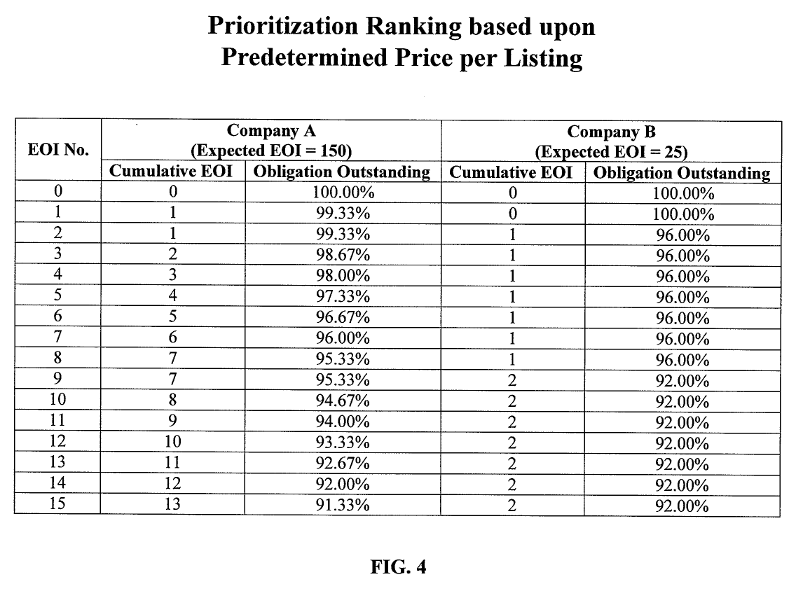

FIG. 3 illustrates a flow chart of the steps of generating search results according to one embodiment of a method for generating prioritized search results in a limited supply system. In one embodiment, the method begins, step 300, by receiving a search request having search request parameters for search results in a limited supply system. As discussed above with respect to FIG. 1, this may be received by the search provider 108 of the system 100. The next step, step 302, includes determining a plurality of search result elements from the limited supply system based on the search request parameters, where each of the search result elements indicate a corresponding listing entity. As discussed above with respect to FIG. 1, this may be performed by the search provider 108 which locates search results associated with the search request in the search content database 110.

The next step, step 304, includes calculating Expression of Interest (EOI) terms for each of the search result elements based on search result obligations between the limited supply system and the listing entity. As described in further detail below in the corresponding descriptions for FIGS. 4-7, a search result obligation includes an obligation that the search provider, e.g. 108 of FIG. 1, has to a listing entity to provide search results associated with the listing entity to a user.

The next step, step 306, includes prioritizing the search result terms based on the corresponding EOI terms. As discussed above with respect to FIG. 1, this may be performed by the processing device 112, through use of the EOI processing element 114.

According to one embodiment, the method by which prioritized search results in a limited supply system are generated is to calculate EOI terms for each of the search results based on a search result obligation owed by the search provider to the listing entity where there is a fixed predetermined price per listing. FIG. 4 illustrates a table of sample results of this embodiment of the invention where search results provided by two listing entities, Company A and Company B, are prioritized based upon the calculated corresponding EOI terms. In this embodiment of the invention, Company A and Company B each provide a value for the expected number of search results that are to be displayed to a user, which is referred to as the Expected EOI. The search provider 108 of FIG. 1 has the obligation to display those search results to a user, which is referred to as the Obligation Outstanding.

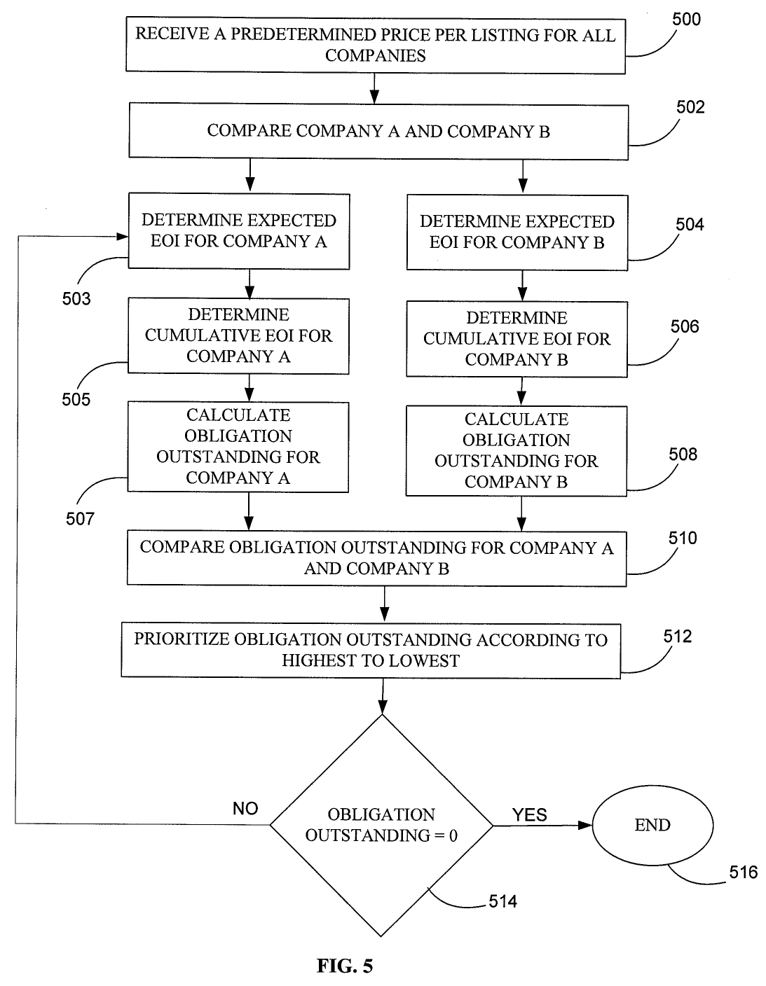

FIG. 5 illustrates a flow chart of the steps of one embodiment where the processing device 112 of FIG. 1, through use of the EOI processing element 114 of FIG. 1, receives a predetermined price per listing of all companies, step 500, and initiates a comparison of Company A and Company B, step 502, in order to prioritize the search results. In order to accomplish the comparison, the Expected EOI is determined for Company A and Company B, steps 503 and 504, which may be accomplished by each company providing their Expected EOI. For example, an Expected EOI may relate to a number of job listings a listing entity may want presented to end-users. As illustrated in FIG. 4, Company A has requested an Expected EOI of 150 responses and Company B has requested an Expected EOI of 25 responses. The next step, step 505, requires a determination of a Cumulative EOI for Company A, which is the total number of interactions by a user with the search result for Company A. A determination of the Cumulative EOI for Company B is also performed, step 506.

The next step, step 507, then requires a calculation of the Obligation Outstanding by the search provider, e.g. 108 of FIG. 1, to display the search results for Company A. A determination of the Obligation Outstanding for Company B is also performed, step 508. In order to calculate the Obligation Outstanding for each company, it is the percentage of the difference of the Expected EOI minus the Cumulative EOI divided by the Expected EOI. The calculation can be expressed by the following formula:

$$\begin{matrix}EQ . 1 \text{:} & \\ Obligation Outstanding = \frac{Expected EOI - Cumulative EOI}{Expected EOI} & \end{matrix}$$

In a first iteration, as illustrated in FIG. 4, a Cumulative EOI would be zero for both Company A and Company B as neither company A nor Company B has presented content relating to the limited supply system. In such a case, the Obligation Outstanding is 100% for both Company A and Company B. However, a user when presented with search results for the limited supply system of Company A and Company B may decide to view or interact with the search result of Company A only. Therefore, in a second iteration, the Cumulative EOI for Company A is now one, but the Cumulative EOI for Company B is still zero. Therefore, in the second iteration, the Obligation Outstanding for Company A is calculated to be 99.33%, while the Obligation Outstanding for Company B still remains 100%.

As illustrated in FIG. 5, a comparison is then performed of the Obligation Outstanding for Company A and Company B, step 510, by the EOI processing element 114 of FIG. 1. The next step, step 512, includes a prioritization of the Obligation Outstanding for each company according to highest is lowest by the EOI processing element 114 of FIG. 1. Since the Obligation Outstanding for Company B is higher than the Obligation Outstanding for Company A, the limited supplies content of Company B is ranked higher and the limited supplies content for Company A prior to the next iteration. Therefore, as illustrated in FIG. 4, in the third iteration, Company B now has a Cumulative EOI of one, while the Cumulative EOI for Company A remains at one. However, the Obligation Outstanding for Company B is now 96%, while the Obligation Outstanding for Company A remains at 99.33%. Therefore, a comparison of the Obligation Outstanding for each company results in the search results of the limited supply system of Company A ranked higher than the search results the limited supply system of Company B.

In the event that the Obligation Outstanding is equal for both Company A and Company B, a plurality of secondary factors may be utilized for ordering the search results, such as a click through rate factor or an apply rate factor, determined by the CTR/AR processing element 116 of FIG. 1, a relevance factor, determined by the relevance processing element 118 of FIG. 1, or other factors, such as brand affinity, determined by the other factor processing element 120 of FIG. 1.

As illustrated in FIG. 5, after each iteration, a determination is made as to the value of the Obligation Outstanding. If the Obligation Outstanding is greater than zero, then the method repeats, step 514; if the Obligation Outstanding is equal to zero, then the method ends, step 516.

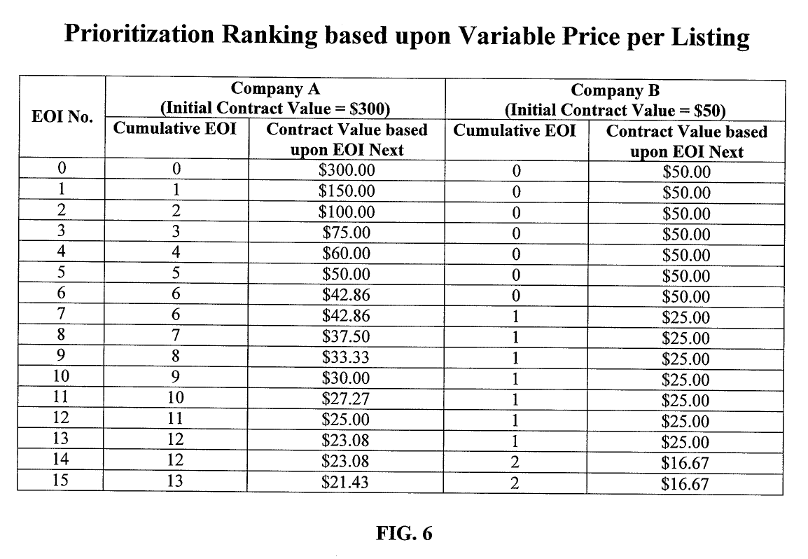

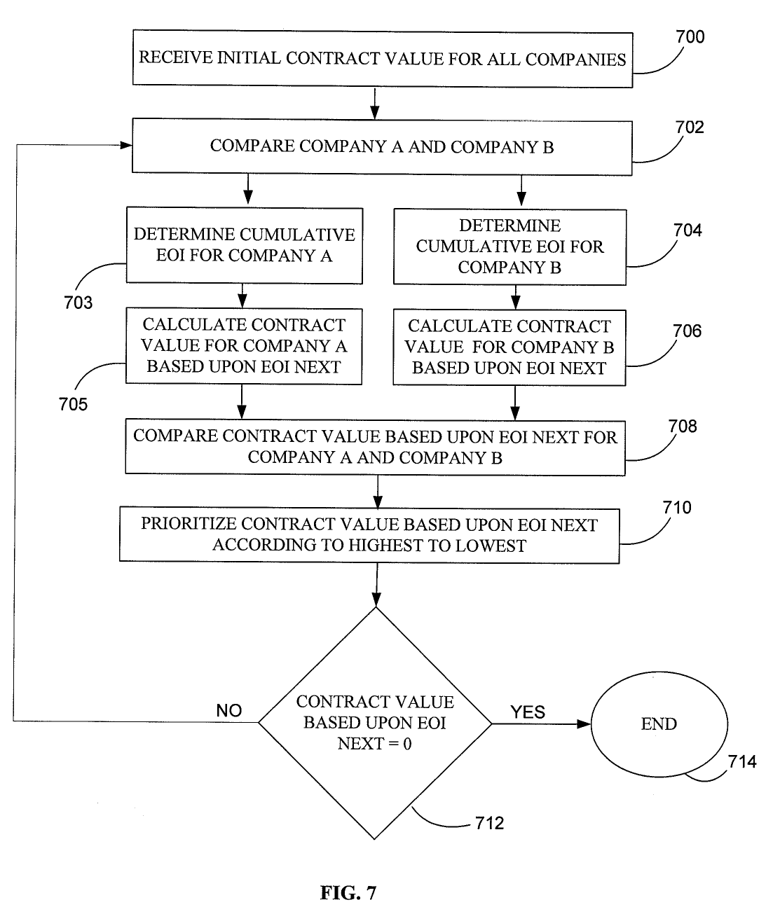

In another embodiment, the method by which prioritized search results in a limited supply system are generated is to calculate EOI terms for each of the search results elements based on a search result obligation owed by the search provider to the listing entity where there is a variable price per listing. FIG. 6 illustrates a table of sample results of this embodiment of the invention where search results provided by two listing entities, Company A and Company B, are prioritized based upon the calculated corresponding EOI terms. In this embodiment, Company A and Company B each provides an initial monetary contract value to display search results to a user. In one example, the initial monetary contract value corresponds to monetary value which a listing entity pays to a search provider to present job listings to a user. The search provider, e.g. 108 of FIG. 1, has the obligation to display those search results to a user, which is referred to as the Contract Value based upon EOI Next.

FIG. 7 illustrates a flow chart of the steps of this embodiment where the processing device 112, through use of the EOI processing element 114, receives an initial monetary contract value for Company A and Company B, step 700, and initiates a comparison of Company A and Company B, step 702, in order to prioritize the search results in a limited supply system.

As illustrated in FIG. 6, Company A provides an initial monetary contract value of $300.00 and Company B provides an initial monetary contract value of $50.00. In order to accomplish the comparison, a determination of a Cumulative EOI for Company A, which is the total number of interactions by a user with the search result for Company A, step 703. A determination of the Cumulative EOI for Company B is also performed, step 704.

The next step, step 705, requires a calculation of the Contract Value based upon EOI Next for Company A. The Contract Value based upon EOI next is also calculated for Company B, step 706. In order to calculate the Contract Value based upon EOI Next for each company, it is the quotient of the initial contract value offered by each company and the sum of the Cumulative EOI plus one. The calculation can be expressed by the following formula:

$$\begin{matrix}EQ . 2 \text{:} & \\ \begin{matrix}Contract Value \\ based upon \\ EOI Next\end{matrix} = \frac{Contract Value}{Cumulative EOI + 1} & \end{matrix}$$

In a first iteration, as illustrated in FIG. 6, a Cumulative EOI would be zero for both Company A and Company B as neither company A nor Company B has presented content for the limited supply system. In such a case, the Contract Value based upon EOI Next is the initial monetary contract value offered by each company. However, a user when presented with search results for the limited supplies content of Company A and Company B may then decide to view or interact with the search results of Company A only. Therefore in a second iteration, the Cumulative EOI for Company A is now one, but the Cumulative EOI for Company B is still zero. Therefore, in the second iteration, the Contract Value based upon EOI Next for Company A is calculated to be $150.00 while the Contract Value based upon EOI Next for Company B still remains at the original $50.00 value.

As illustrated in FIG. 7, a comparison is then performed of the Contract Value based upon EOI Next for Company A and Company B, step 708, by the EOI processing element 114 of FIG. 1. The next step, step 710, includes a prioritization of the Contract Value based upon EOI Next for each company according to highest is lowest, by the EOI processing element 114 of FIG. 1. Since the Contract Value based upon EOI Next for Company A is higher than the Contract Value based upon EOI Next for Company B, the search result of the limited supply system of Company A is ranked higher than the search result of the limited supply system for Company B prior to the next iteration. Therefore, as illustrated in FIG. 6, in the third iteration, Company A now has a Cumulative EOI of two, while the Cumulative EOI for Company B remains at zero. However, the Contract Value based upon EOI Next for Company A, now at $100.00, is still higher than the Contract Value based upon EOI Next for Company B. Therefore, in a comparison of the Contract Value based upon EOI Next for each company results in the search results for the limited supply system of Company A continues to be ranked higher than the search results for the limited supply system of Company B.

In the event that the Contract Value based upon EOI Next is equal for both Company A and Company B, a plurality of secondary factors may be utilized for ordering the search results similar to those described with respect to FIGS. 4-5.

As illustrated in FIG. 7, after each iteration, a determination is made as to the value of the Contract Value based upon EOI Next. If the Contract Value based upon EOI Next is greater than zero, then the method repeats, step 712; if the Contract Value based upon EOI Next is equal to zero, then the method ends, step 714.

In another embodiment, the method by which prioritized search results in a limited supply system are generated combine prioritizing search result terms based upon the corresponding EOI terms with prioritizing search results based on additional search priority factors. Additional search priority factors can include a relevance factor, a click through rate factor, an application rate factor or a brand affinity factor. In one example, corresponding EOI terms and additional search priority factors may be used to prioritize job listings search results for an employment opportunity system.

Therefore, the present invention improves performance in the prioritization and presentation of search results for content relating to limited supply systems by generating prioritized search results in a limited supply system by EOI terms for each of the search result elements based on search result obligations between the limited supply system and the listing entities.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for generating prioritized search results in a limited supply system, the method comprising:
receiving a search request having search request parameters;
determining a plurality search result elements from the limited supply system based on the search request parameters, where each of the search result elements indicate a corresponding listing entity;
calculating expression of interest (EOI) terms for each of the search results elements based on search result obligations between the limited supply system and the listing entities; and
prioritizing the search result terms based on the corresponding EOI terms.

2. The method of claim 1, wherein the obligation between the limited supply system and the listing entities is a predetermined price per listing, the method further comprising:
for each of the plurality of search result elements, determining a cumulative EOI value and an expected EOI value;
ordering the search result elements in a sequential order based on the relationship of the cumulative EOI value and the expected EOI value for each of the search result elements; and
culling search result elements from the list below a predetermined sequential threshold value.

3. The method of claim 2, wherein the EOI term, for each of the search result elements, is a percentage value of the difference of the expected EOI value minus the cumulative EOI value divided by the expected EOI value.

4. The method of claim 3 further comprising:
when ordering the search result elements, if the EOI terms are the same for two or more search result elements, comparing at least one of a plurality of secondary factors for ordering the search result elements.

5. The method of claim 1, wherein the obligation between the limited supply system and the listing entities is a variable price per listing, the method further comprising:
for each of the plurality of search result elements, determining a cumulative EOI value and a contract value;
ordering the search result elements in a sequential order based on the relationship of the cumulative EOI values and the contract values for each of the search result elements; and
culling search result elements from the list below a predetermined sequential threshold value.

6. The method of claim 5, wherein the EOI term, for each of the search result elements, is an outstanding financial value determined by the contract value divided by a next EOI value.

7. The method of claim 6 further comprising:
when ordering the search result elements, if the EOI terms are the same for two or more search result elements, comparing at least one of a plurality of secondary factors for ordering the search result elements.

8. The method of claim 1 further comprising:
in response to the search request, generating additional search priority factors; and
prioritizing the search results also based on the additional search priority factors.

9. The method of claim 8 wherein the additional search priority factors include at least one of: a relevance factor, a click through rate factor and a brand affinity factor.

10. The method of claim 1 further comprising:
generating a web-based display including the prioritized search results.

11. The method of claim 1 wherein the limited supply system is a jobs database and the search results are job listings.
